(19) United States
(12) Patent Application Publication
(10) Pub. No.: US 2026/0360374 A1
(43) Pub. Date: Nov. 12, 2026

(54) AUDIO OR VIDEO SOURCE WATERMARKING

(71) Applicant: Logitech Europe S.A., Lausanne (CH)

(72) Inventors: Milos CERNAK, Martigny (CH); Zhentao LIU, Zurich (CH)

(21) Appl. No.: 19/529,956

(22) Filed: Feb. 4, 2026

Related U.S. Application Data
(60) Provisional application No. 63/803,111, filed on May 9, 2025.

(51) Int. Cl. G10L 19/018

(52) U.S. Cl. CPC G10L 19/018

(57) ABSTRACT

A method includes receiving, by a first controller included in a first electronic device, an input signal, and deconstructing, by the first controller, the input signal into real signal data and imaginary signal data. The method further includes encoding, by the first controller, the real signal data to generate a real watermark carrier and the imaginary signal data to generate a imaginary watermark carrier, and embedding, by the first controller, the real watermark carrier and the imaginary watermark carrier with an encoded watermark to generate a real embedded watermark carrier and a imaginary embedded watermark carrier. The first controller combines the real embedded watermark carrier and the imaginary embedded watermark carrier into an output signal, the output signal including the input signal embedded with the encoded watermark. The first controller transmits the output signal to a second electronic device.

### CROSS-REFERENCE TO RELATED APPLICATIONS

This application claims benefit of U.S. provisional patent application Ser. No. 63/803,111, filed May 9, 2025, which is hereby incorporated herein by reference.

### BACKGROUND

### Field

Embodiments of the present disclosure generally relate to systems and methods of adding a watermark to a data stream to detect and validate the authenticity and integrity of the data stream.

### Description of the Related Art

The reliance on audio and video communication tools increases the need to ensure the authenticity and integrity of a data stream (such as audio data, video data, or the like). The increasing risk of cybersecurity threats, including, but not limited to, deepfakes, audio manipulation, video manipulation, and other forms of data tampering requires the need for improved data security mechanisms. Current methods of detecting data tampering include passive methods that include training binary classifiers to differentiate between natural and synthesized audio. However, these passive techniques have diminishing effectiveness as generative models improve, limited generalization across different types of synthesized audio, and computational overhead.

Thus, there is a need for a proactive system, device, and method that can detect audio and/or video content that ensures that the source of audio data or video data can be traced and verified, and prevent unauthorized and/or malicious alterations of the audio data or video data.

### SUMMARY

According to one or more embodiments, a method includes receiving, by a first controller included in a first electronic device, an input signal, deconstructing, by the first controller, the input signal into real signal data and imaginary signal data, encoding, by the first controller, the real signal data to generate a real watermark carrier and the imaginary signal data to generate a imaginary watermark carrier, embedding, by the first controller, the real watermark carrier and the imaginary watermark carrier with an encoded watermark to generate a real embedded watermark carrier and a imaginary embedded watermark carrier, combining, by the first controller, the real embedded watermark carrier and the imaginary embedded watermark carrier into an output signal, the output signal comprising the input signal embedded with the encoded watermark, and transmitting, by the first controller, the output signal to a second electronic device.

According to one or more embodiments, an output signal includes a set of audio data or video data, and an encoded watermark embedded within the set of audio data or video data, wherein the encoded watermark is robust with respect to benign modifications to the set of audio data or video data and fragile with respect to malicious modifications to the set of audio data or video data.

According to one or more embodiments, a communication system, includes a first controller included in a first electronic device, the first controller configured to:

receive an input signal, deconstruct the input signal into real signal data and imaginary signal data, encode the real signal data to generate a real watermark carrier and the imaginary signal data to generate a imaginary watermark carrier, embed the real watermark carrier and the imaginary watermark carrier with an encoded watermark to generate a real embedded watermark carrier and a imaginary embedded watermark carrier, combine the real embedded watermark carrier and the imaginary embedded watermark carrier into an output signal, the output signal comprising the input signal embedded with the encoded watermark, and transmit the output signal to a second electronic device.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates a conferencing environment that includes an electronic communication system, according to one or more embodiments.

FIG. 2A illustrates a schematic diagram of a first controller and a second controller of the electronic communication system used to watermark an input signal to detect a malicious attack on the input signal, according to one or more embodiments.

FIG. 2B illustrates a schematic diagram of the input signal provided to the first controller and the output signal provided to the second controller, according to one or more embodiments.

FIG. 3 illustrates a flow diagram of a method of watermarking an input signal to detect a malicious attack on the input signal, according to one or more embodiments.

FIG. 4 illustrates a schematic diagram of the first controller of the communication system during training to watermark an input signal used to detect a malicious attack on the input signal, according to one or more embodiments.

FIG. 5 illustrates a flow diagram of a method of training a watermark encoder to watermark an input signal used to detect a malicious attack on the input signal, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the disclosure include a semi-fragile watermarking system that is designed to authenticate audio and/or video content provided from audio and/or video devices. Aspects of the disclosure provided herein include semi-fragile watermarks that exhibit robustness against benign modifications, which do not change content semantics (e.g., denoising, normal conferencing software alterations, etc.) and detect malicious audio and/or video data modifications (e.g., deepfakes) that change content semantics.

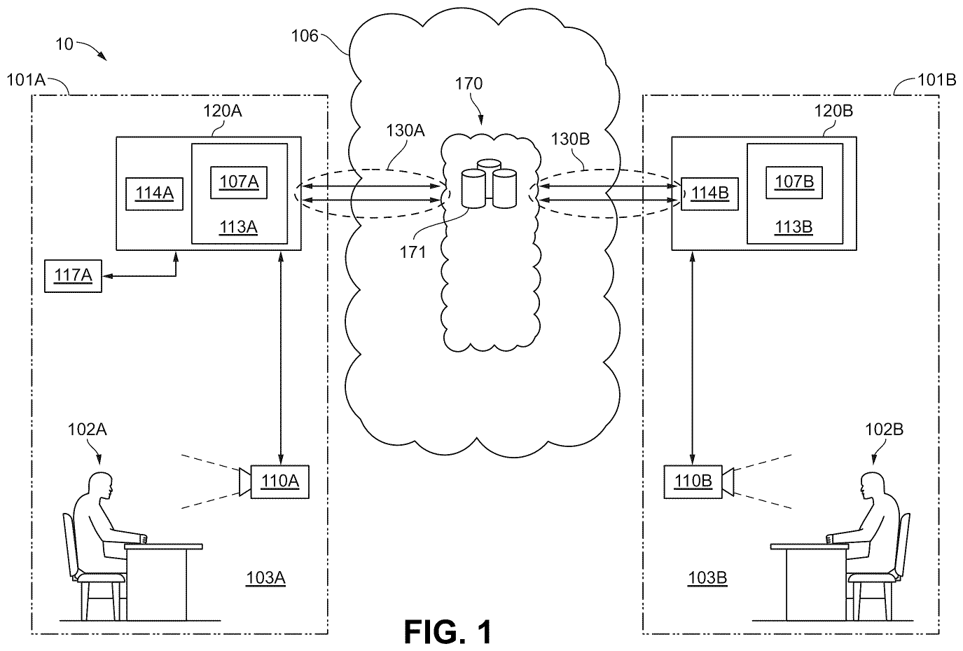

FIG. 1 is a diagram of an electronic communication system, such as a conferencing calling system, or simply a communication system 10, according to one or more embodiments. The communication system 10 includes a first remote location 101A and a second remote location 101B. The related equipment at each remote location 101A, 101B can include at least one microphone, at least one electronic device for providing the call stream to and from the remote locations 101A, 101B to the users, and at least one controlling device for handling the distribution of the different types of data exchanged between the remote locations 101A, 101B. In some cases, the communication system 10 can include one or more cameras, at least one microphone, at least one electronic device for providing the call stream to and from the remote locations 101A, 101B, and at least one controlling device for handling the distribution of the different types of data exchanged between the remote locations 101A, 101B. The related equipment for each remote location 101A, 101B is described in more detail below.

The second remote location 101B is at a remote location relative to the first remote location 101A. Stated differently, a first user 102A may be located in the first remote location 101A and a second user 102B may be located at the second remote location (or vice versa). For example, the second remote location 101B may include one or more remote locations that each include equipment used to facilitate the communication between users positioned at the various locations. Stated differently, the second remote location 101B may represent one or more remote locations occupied by one or more users. A remote location can be any location where it would not be feasible for a user at the remote location to communicate with another user without the use of an external device (e.g., an electronic device, such as a smartphone, tablet, laptop, microphone, etc.). The communication between the first user 102A (i.e., the first remote location 101A) and the second user 102B (i.e., the second remote location 101B) can be connected through a network 106. The network 106 generally represents any data communications network suitable for the transmission and receipt of audible signals and/or video data.

The communication system 10 enables the first user 102A and the second user 102B to receive audible information, such as verbal communications, and/or video data in the form of images displayed at a certain frame rate. For example, audio and/or video data can be exchanged through a communication software application 170 including but not limited to, Microsoft® Skype®, Microsoft® Teams®, Zoom®, Google® Hangouts®, a phone call app, a video game, streaming applications, or the like. The communication software application can include a communication node 171 to allow the first user 102A located at the first remote location 101A to communicate with the second user 102B located at the second remote location 101B. Although a first user 102A is in a first remote location 101A during a call with a second user 102B that is in a second remote location is described herein, this is only intended as an example, and any number of users in any number of remote locations can be communicating using the communication system 10. The electronic devices 120A, 120B can communicate with the communication node 171 of the communication software application 170 through corresponding first and second communication links 130A, 130B.

Optionally, auxiliary data can also be exchanged between the respective remote locations 101A, 101B through the communication software application 170 to further enhance the interaction between the users 102A, 102B. In some embodiments, the auxiliary data can be exchanged using a separate cloud service by use of a separate communication link. This auxiliary data can include any data exchanged between the remote locations 101A, 101B. For example, auxiliary data can include data related to instant messaging applications, screen sharing applications, or electronic document sharing applications.

The related equipment for the remote locations 101A, 101B can include audio devices, cameras, microphones, virtual reality (VR) devices, augmented reality (AR) devices, and display devices. For example, each remote location 101A, 101B includes various electronic devices. For example, the first remote location 101A includes one or more audio devices, such as one or more microphones 117A. The second remote location 101B can include one or more audio devices. Optionally, the remote locations 101A, 101B may include a camera device (e.g., video camera). For example, the first remote location 101A includes a camera device 110A, the one or more microphones 117A, and/or an electronic device 120A. The second remote location 101B includes a camera device 110B, and/or an electronic device 120B.

The one or more microphones 117A and/or the camera device 110A can be used to capture an input signal generated in the first remote location 101A, and transmit the input signal to the second electronic device 120B used by the second user 102B via the communication software application 170 including but not limited to, Microsoft® Skype®, Microsoft® Teams®, Zoom®, Google® Hangouts®, a phone call app, a video game or the like. In one or more embodiments, the input signal includes, but is not limited to, a single-channel audio signal, a multi-channel audio signal, a video signal, and combinations thereof.

In one or more embodiments, the communication system 10 may be used in a communication between the first user 102A and the second user 102B. It should be understood, that this is for example purposes only, and the call may include more than two users located in two or more remote locations. For example, purposes only, embodiments herein, will be described as an example of providing an input signal captured in the first remote location 101 (e.g., from the first user 102A) to the second remote location 101B (e.g., to the second user 102B). Furthermore, embodiments herein will be described from the perspective of the first user 102A. The first remote location 101A is defined herein as the near end, and the second remote location 101B is defined herein as the far end from the perspective of the first user 102A. It is understood that the communication system 10 is also able to transmit input signal(s) captured within the second remote location 101B to the first remote location 101A in the same manner described below.

As will be described in more detail below, attacks such as deepfakes on input signals are becoming more prevalent. Embodiments herein, relate to a process and a system that adds a watermark to the input signal, which is then used to determine whether the input signal has been maliciously tampered with at any time between when the input signal was generated at a first location and the generated input signal was received at the second location. In particular, embodiments herein relate to adding a semi-fragile watermark to an input signal that is fragile to malicious modifications to the input signal (i.e. is destroyed) and is robust (i.e. is not affected) by benign modifications to the input signal.

In one or more embodiments, the electronic device 120A includes a controller 114A and a memory 113A. The controller 114A may be a processor that analyzes information and carries out a series of executable scripts, e.g., stored in the memory 113A. In one or more embodiments, the controller 114A may comprise an application-specific integrated circuit (ASIC) device, a system on chip (SOC), or any other processing unit known in the art. The memory 113A may be programmed for short term and/or long term memory storage. The memory 113A may include both volatile and non-volatile memories. The memory 113A may store a program 107A that may be used in conjunction with the controller 114A to watermark the input signal.

In one or more embodiments, the electronic device 120B includes a controller 114B and a memory 113B. The controller 114B may be a processor that analyzes information and carries out a series of executable scripts, e.g., stored in the memory 113B. Similarly, in one or more embodiments, the controller 114B may comprise an application-specific integrated circuit (ASIC) device, a system on chip (SOC), or any other processing unit known in the art. The memory 113B may be programmed for short term and/or long term memory storage. The memory 113B may include both volatile and non-volatile memories.

The memory 113B may store a program 107B that may be used in conjunction with the controller 114B. The controller 114B receives the input transmitted via the network 106 and decodes the received signal to check for the watermark.

### Methods for Watermarking an Input Signal

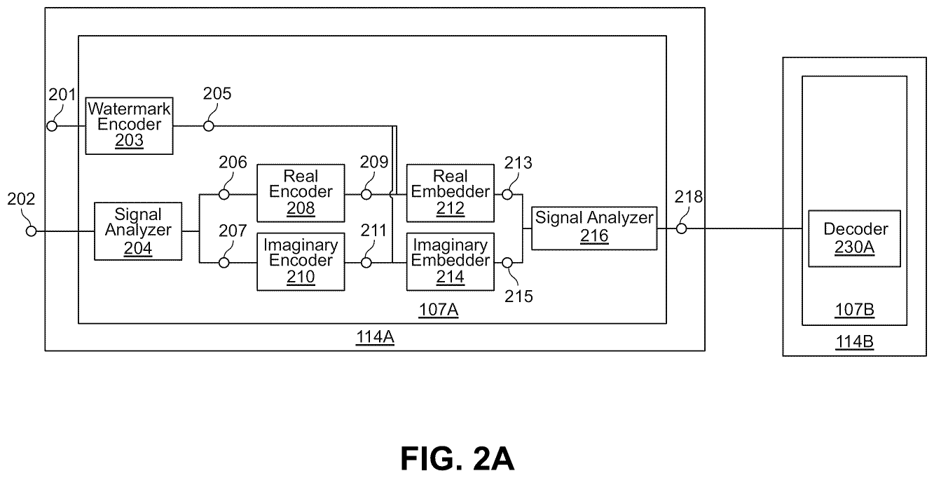

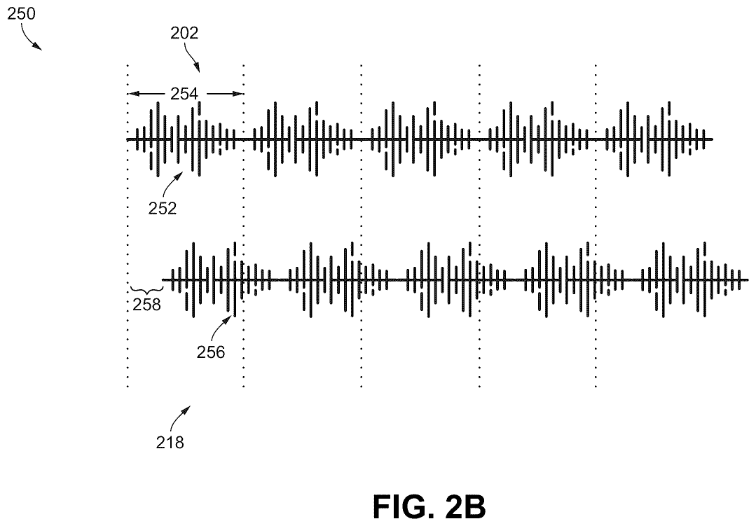

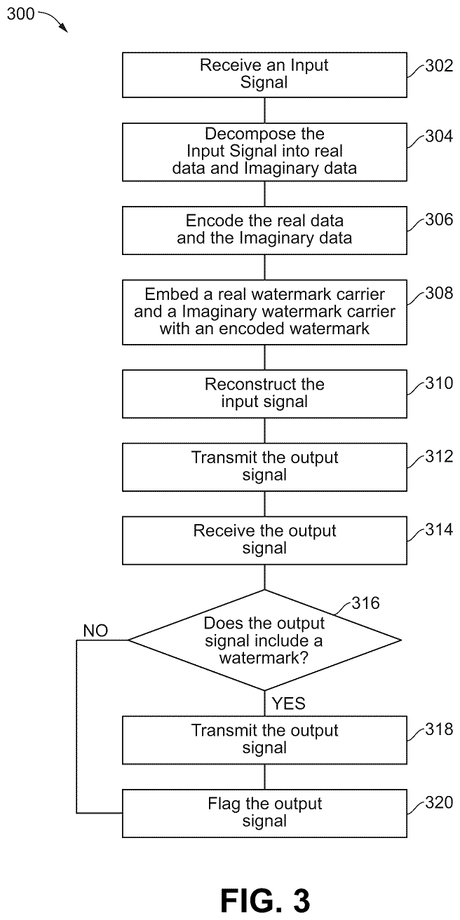

FIG. 2A illustrates a schematic diagram of a controller 114A and a controller 114B of the communication system 10 used to watermark an input signal to detect a malicious attack on the input signal, according to one or more embodiments. FIG. 3 illustrates a flow diagram of a method 300 of watermarking an input signal to detect a malicious attack on the input signal, according to one or more embodiments.

As shown in FIG. 2A, the program 107A stored in the memory 113A and executed by the controller 114A further includes a watermark encoder 203, a signal analyzer 204, a real encoder 208, an imaginary encoder 210, a real embedder 212, an imaginary embedder 214, and a signal analyzer 216. In one or more embodiments, the watermark encoder 203, the signal analyzer 204, the real encoder 208, the imaginary encoder 210, the real embedder 212, the imaginary embedder 214, and the signal analyzer 216 are separate algorithms. In other embodiments, the watermark encoder 203, the signal analyzer 204, the real encoder 208, the imaginary encoder 210, the real embedder 212, the imaginary embedder 214, and the signal analyzer 216 are included in the same algorithm.

At operation 302 of the method 300, the controller 114A receives an input signal 202. In one or more embodiments, the input signal 202 is a signal that is generated in and transmitted from the first remote location 101A to the second remote location 101B. The input signal 202 is captured in real time and may be any suitable type of input signal such as a single-channel audio signal, a multi-channel audio signal, a video signal, or combinations thereof, wherein the input signal 202 includes at least one set of data. In one or more embodiments, the input signal 202 is captured using the one or more microphones 117A and/or the camera device 110A and transmitted to the controller 114A.

At operation 304 of the method 300, the controller 114A decomposes the input signal 202 into a decomposed input signal using the signal analyzer 204. In one or more embodiments, the controller 114A decomposes the input signal 202 into a decomposed input signal that includes real signal data 206 and imaginary signal data 207. In one or more embodiments, the signal analyzer 204 decomposes the input signal 202 using any suitable decomposition method, such as a Complex Short Time Fourier Transform (STFT). In one or more embodiments, the signal analyzer decomposes the input signal 202 using Eq. 1 shown below, where “r” represents the real signal data 206, “i” represents the imaginary signal data 207, and “a” represents the data stored within the input signal 202.

r,i=ComplexSTFT(a) (Eq. 1)

At operation 306 of the method 300, the controller 114A encodes the decomposed input signal. The controller 114A encodes the decomposed input signal by transforming the decomposed input signal into the real signal data 206 and the imaginary signal data 207. The controller 114A encodes the real signal data 206 using a real encoder 208 to generate a real watermark carrier 209. The controller 114A encodes the imaginary signal data 207 using an imaginary encoder 210 to generate a imaginary watermark carrier 211. The real encoder 208 generates the real watermark carrier 209 using Eq. 2 shown below, where Enᵣ represents a real encoder 208 function and cᵣ represents the real watermark carrier 209. The imaginary encoder 210 generates the imaginary watermark carrier 211 using Eq. 3 shown below where Enᵢ represents an imaginary encoder 210 function and cᵢ represents the imaginary watermark carrier 211. In one or more embodiments, the real encoder function Enᵣ and the imaginary encoder function Enᵢ are neural network blocks (components). They are thus learnable and transform the real signal data 206 and the imaginary signal data 207 into a form in which they can be embedded.

cᵣ=ENᵣ(r) (Eq. 2)

cᵢ=ENᵢ(i) (Eq. 3)

At operation 308 of the method 300, the controller 114A embeds the decomposed input signal with an encoded watermark 205. In one or more embodiments, embedding the decomposed input signal with an encoded watermark includes embedding the real watermark carrier 209 and the imaginary watermark carrier 211 with the encoded watermark 205. In one or more embodiments, embedding the real watermark carrier 209 and the imaginary watermark carrier 211 with a watermark includes the controller 114A first generating a watermark 201. Then using the watermark encoder 203, the controller 114A generates an encoded watermark 205 that can be inserted within a portion of the data found within the real watermark carrier 209 and/or the imaginary watermark carrier 211. In one or more embodiments, the watermark 201 is encoded to generate the encoded watermark 205 using Eq. 4 shown below, where w represents the encoded watermark 205, EN_{w} represents a watermark encoding function and m represents the watermark 201.

w=EN_{w}(m) (Eq. 4)

In one or more embodiments, the encoded watermark 205 is a semi-fragile watermark. The encoded watermark 205 is robust against benign modifications and fragile against malicious modifications to an output signal 218 generated and transmitted from the controller 114A to the controller 114B. In one or more embodiments, most benign and malicious modifications will typically occur between the output of the controller 114A and the input of the controller 114B. Benign modifications are modifications that do not intentionally violate the semantics, or alter the core information or data conveyed in the data provided within the output signal 218 and/or are performed by the communication system 10. Benign modifications include, but are not limited to, noising, compression, amplitude scaling, requantization, resampling, cropping, filtering, denoising, encoding, decoding, style transfer, or the like, which do not alter the core information or data that is conveyed in the output signal 218. Malicious modifications are modifications that intentionally violate the semantics, or alter the core information or data, of the output signal 218 and/or are not performed by the communication system 10. Malicious modifications include, but are not limited to, audio pitch shifting, voice conversion, speech editing, image alteration, text alteration, the addition of deepfakes, or the like. Stated differently, the encoded watermark is destroyed by a malicious modification and unaffected by a benign modifications of the watermarked input signal 202 to detect a malicious attack on the output signal 218.

In one or more embodiments, the watermark encoder 203 is an artificial intelligence (AI) algorithm stored in the memory 113A executed by the controller 114A. In general, an AI algorithm (and AI models) will include processes that require combining large sets of data with intelligent, iterative processing algorithms to learn from patterns and features in the data (e.g., the input signal 202) that it has analyzed and/or is analyzing. Each time an AI algorithm (and AI model) runs a round of data processing, it will test and measure its own performance so as to develop additional expertise based on the performance of these activities. In this case, the watermark encoder 203 is executed by the controller 114A and is used to encode the watermark 201 so that the watermark 201 is robust against benign modifications to the input signal 202 and fragile against malicious modifications to the input signal 202 based on received prior and current data. The watermark encoder 203 is also used to encode the watermark 201 so that the watermark 201 is imperceptible and difficult to distinguish from the originally generated input signal 202 based on received prior and current data. Details regarding the training of the watermark encoder 203 are described in more detail below.

The encoded watermark 205 is provided to the real embedder 212 and the imaginary embedder 214. The real embedder 212 embeds the real watermark carrier 209 with the encoded watermark 205 to generate a real embedded watermark carrier 213. The imaginary embedder 214 embeds the imaginary watermark carrier 211 with the encoded watermark 205 to generate an imaginary embedded watermark carrier 215. In one or more embodiments, the real watermark carrier 209 is embedded using Eq. 5 shown below, where eᵣ represents the real embedded watermark carrier 213 and EMᵣ represents an embedder function. Similarly, the imaginary watermark carrier 211 is embedded using Eq. 6 shown below, where eᵢ represents the imaginary embedded watermark carrier 215.

eᵣ=EMᵣ(cᵣ,cᵢ,w) (Eq. 5)

eᵢ=EMᵢ(cᵣ,cᵢ,w) (Eq. 6)

In other embodiments, only one of the real watermark carrier 209 and the imaginary watermark carrier 211 is embedded with the encoded watermark 205. Stated differently, the controller 114A only generates a real embedded watermark carrier 213 or a imaginary embedded watermark carrier 215. However, there are significant advantages in embedding the real watermark carrier 209 and the imaginary watermark carrier 211 since the imaginary component looks like noise and it is difficult for external systems to learn from and thus avoid the watermarking techniques disclosed herein.

Due to the arbitrary length of the input signal 202 (because the input signal 202 is transmitted in real-time), the controller 114A generates embedded watermarks that watermark portions of data within the input signal 202. In some embodiments, the controller 114A generates embedded watermarks at desired intervals in time or before, during, or after known or determined intervals within the received input signal 202. FIG. 2B illustrates a schematic diagram 250 of the input signal 202 provided to the controller 114A, and the output signal 218 provided to the controller 114B, according to one or more embodiments. Because the input signal 202 is transmitted in real time, the input signal 202 is of arbitrary length from the perspective of the controller 114A. To combat this, the controller 114A, using the watermark encoder 203, encodes the input signal 202 with encoded watermark(s) 205 as the input signal 202 is received. In one or more embodiments, the controller 114A embeds the input signal 202 with encoded watermark(s) 205 each time a threshold quantity of time 254 passes. By encoding input signal 202 with encoded watermark(s) 205 each time the threshold quantity of time 254 passes, the controller 114A forms portions 252 of the input signal 202 that each include an encoded watermark 205. Stated differently, the controller 114A embeds each portion 252 of the input signal 202 with an encoded watermark 205. Furthermore, in one or more embodiments, as understood by those with ordinary skill in the art, adding encoded watermark(s) adds latency 258 to the output signal 218. Stated differently, portions 256 of the output signal 218 are time-shifted from the portions 252 of the input signal 202 due to the encoded watermark(s) 205. The threshold hold quantity of time is from about 250 ms to about 1 second and the latency is from about 20 ms to about 60 ms.

At operation 310 of the method 300, the controller 114A reconstructs the deconstructed input signal to generate an output signal 218 using the signal analyzer 216. In one or more embodiments, reconstructing the input signal 202 includes combining the real embedded watermark carrier 213 and the imaginary embedded watermark carrier 215 into a single watermark containing (output) signal. As noted above, in one or more embodiments, only one of the real watermark carrier 209 or the imaginary watermark carrier 211 are embedded with the encoded watermark 205. If only the real watermark carrier 209 is embedded with the encoded watermark 205, the reconstructed input signal 202 includes combining the real embedded watermark carrier 213 with the imaginary watermark carrier 211. If only the imaginary watermark carrier 211 is embedded with the encoded watermark 205, the reconstructed input signal 202 includes combining the imaginary embedded watermark carrier 215 with the real watermark carrier 209.

In one or more embodiments, the signal analyzer 216 reconstructs the input signal 202 using any suitable reconstruction process such as an inverse complex (ISTFT) as shown below in Eq. 7, where a_{w} represents the output signal 218.

a_{w}(r,i)=ComplexISTFT(eᵣ,eᵢ) (Eq. 7)

At operation 312 of the method 300, the output signal 218 is transmitted to the second electronic device 120B. In one or more embodiments, the output signal 218 is transmitted by the controller 114A to the controller 114B of the second electronic device 120B via the network 106. Stated differently, the controller 114A transmits the output signal 218 to the communication software application 170 and the communication software application 170 transmits the output signal 218 to the controller 114B.

At operation 314 of the method 300, the electronic device 120B (the controller 114B) receives the output signal 218. As noted above, the controller 114B receives the output signal 218 from the controller 114A (the first electronic device 120A) via the network 106.

At operation 316 of the method 300, the controller 114B determines whether the output signal 218 includes the encoded watermark 205. As noted above, because the encoded watermark 205 is semi-fragile, if the encoded watermark 205 is not present in the output signal 218, the input signal 202 has undergone a malicious modification. The decoder 230A does a comparison between the analyzed transmitted components (real and imaginary parts) that were picked up by the decoder and an expected watermark message m to determine whether the encoded watermark 205 is present. In one or more embodiments, to determine if the semi-fragile watermark is present the controller 114A decodes the output signal 218 using the decoder 230A included in the program 107B (FIG. 1). The controller 114B then determines whether the output signal 218 includes the encoded watermark 205.

During operation 316, in an effort to determine if the encoded watermark 205 is present and/or unaltered in the output signal 218, the controller 114B may decompose the output signal 218 into a decomposed output signal using a signal analyzer (such as decoder 230A) of the controller 114B. In one or more embodiments, the controller 114B decomposes the input signal 202 into a decomposed output signal that includes real signal data 218A and imaginary signal data 218B. In one or more embodiments, the signal analyzer decomposes the output signal 218 using any suitable decomposition method, such as a Complex Short Time Fourier Transform (STFT). In some embodiments, metadata within the received output signal 218 can include instructions or coded information relating to what decomposition method is to be performed by the controller 114B. In one or more embodiments, the signal analyzer of the controller 114B decomposes the output signal 218 using Eq. 1 shown above. The controller 114B then analyzes one or more portions (i.e., real signal data 218A and/or imaginary signal data 218B) of the decomposed output signal 218 to determine if the encoded watermark 205 is present or has been altered in some way. In some embodiments, one or more algorithms stored within the memory of the controller 114B include information relating to the attributes of a desirable or an unaltered encoded watermark 205. In some embodiments, the algorithm can be stored within the controller 114B prior to the performance of the activities described in method 300 are performed.

If the output signal 218 includes the encoded watermark 205, the method 300 proceeds to operation 318 and the output signal is transmitted to the electronic device 120B. If the output signal 218 does not include the encoded watermark 205, the method 300 proceeds to operation 320 and the output signal 218 is flagged by the controller 114B. In one or more embodiments, flagging the output signal 218 includes, but is not limited to, adding a warning to the output signal 218 that informs the second user 102B that the output signal 218 has undergone a malicious modification or the controller 114B destroys the output signal 218.

Additionally, or alternatively, during operation 316, decoding the output signal 218 includes determining the probability the encoded watermark 205 is within the output signal 218. If the probability that the encoded watermark 205 is within the output signal 218 is greater than or equal to a threshold probability, the method 300 proceeds to operation 318 and the output signal is transmitted to the electronic device 120B. If the probability that the encoded watermark 205 is within the output signal 218 is less than a threshold probability, the method 300 proceeds to operation 320 and the output signal 218 is flagged by the controller 114B. In one or more examples, the threshold probability is from about 0.5 to about 0.9, for example 0.7.

### Methods for Training a Watermark Encoder

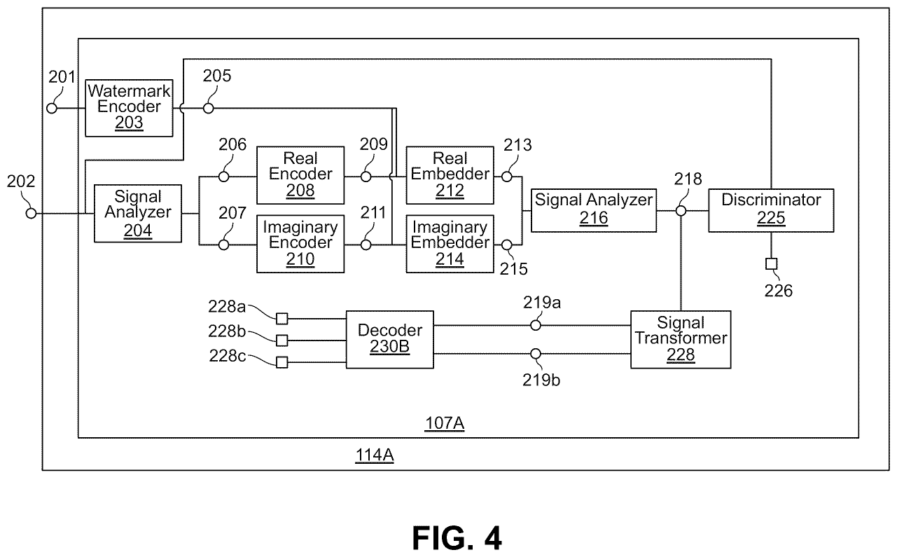

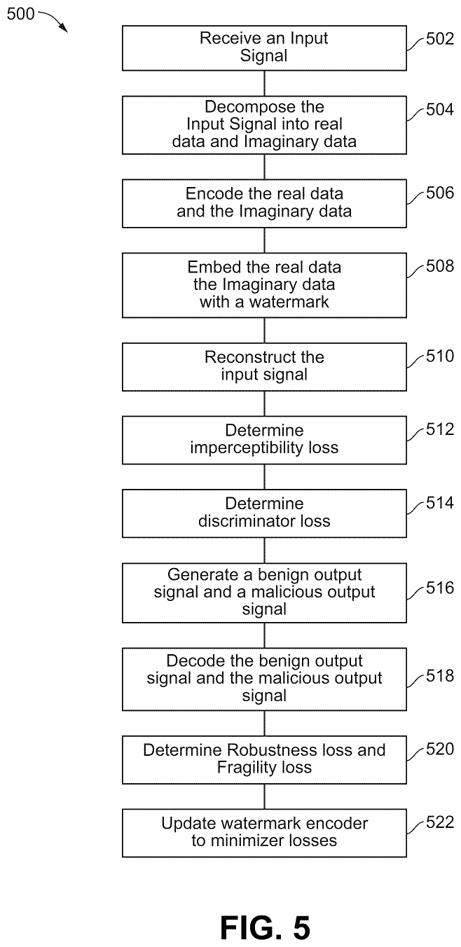

FIG. 4 illustrates a schematic diagram of a controller 114A of the communication system 10 during training to watermark an input signal so that a malicious attack on the input signal can be detected by a downstream controller (e.g., controller 114B), according to one or more embodiments. FIG. 5 illustrates a flow diagram of a method 500 for training a watermark encoder to watermark an input signal so that a malicious attack on the input signal can be detected, according to one or more embodiments.

As illustrated in FIG. 4, the controller 114A further utilizes the program 107A, a discriminator 225, a signal transformer 228, and a decoder 230B.

In one or more embodiments, the discriminator 225, the signal transformer 228, and the decoder 230B are separate algorithms stored in the memory 113A that are executed by the controller 114A. In other embodiments, the discriminator 225, the signal transformer 228, the decoder 230B, the watermark encoder 203, the signal analyzer 204, the real encoder 208, the imaginary encoder 210, the real embedder 212, the imaginary embedder 214, and the signal analyzer 216 are included in a same algorithm stored in the memory 113A that is executed by the controller 114A.

At operation 502 of the method 500, the controller 114A captures an input signal 202 from the electronic device 120A. In one or more embodiments, the input signal 202 is a signal that is generated in and transmitted from the first remote location 101A to the second remote location 101B in real time, such as a single-channel audio signal, a multi-channel audio signal, a video signal, or combinations thereof. In one or more embodiments, the input signal is captured using one or more microphones 117A and/or the camera device 110A.

At operation 504 of the method 500, the controller 114A, using the signal analyzer 204, decomposes the input signal 202 into a decomposed input signal. The controller 114A decomposes the input signal 202 into a decomposed input signal in the same manner described in operation 304 of the method 300.

At operation 506 of the method 500, the controller 114A encodes the decomposed input signal. In one or more embodiments, encoding the decomposed input signal includes encoding the real signal data 206 and the imaginary signal data 207. The controller 114A encodes the real signal data 206 using the real encoder 208 to generate the real watermark carrier 209. The controller 114A encodes the imaginary signal data 207 using the imaginary encoder 210 to generate the imaginary watermark carrier 211. The controller 114A encodes the real signal data 206 and the imaginary signal data 207 in the same manner described in operation 306 of the method 300.

At operation 508 of the method 500, the controller 114A embeds the decomposed input signal with the encoded watermark 205. The controller 114A embeds the decomposed output signal with the encoded watermark 205 in the same manner described in operation 308 of the method 300.

At operation 510 of the method 500, the controller 114A reconstructs the deconstructed input signal to generate an output signal 218 using the signal analyzer 216. The controller 114A reconstructs the input signal in the same manner described in operation 310 of the method 300.

At operation 512 of the method 500, the controller 114A determines the imperceptibility loss of the output signal 218. In one or more embodiments, the encoded watermark 205 should be imperceptible to a user (the user 101B). Therefore, the controller 114A determines the similarity between the input signal 202 and the output signal 218. The controller 114A trains the watermark encoder 203 to reduce the imperceptibility loss. In one or more embodiments, the imperceptibility loss is determined using any suitable calculation, such as, determining the mean squared error (MSE), and thus the magnitude of the difference between in the input signal 202 and the output signal 218. For example, the imperceptibility loss can be determined using Eq. 8 shown below, where “Lᵢ” represents the magnitude of the imperceptibility loss, “a” represents the input signal 202, and “a_{w}” represents the output signal 218. In some embodiments, during one or more of the operations performed during the performance of method 500, the determined MSE is compared with one or more threshold values stored in the memory of the controller 114A to determine if a desired imperceptibility loss has been achieved.

Lᵢ=MSE(a,a_{w}) (Eq. 8)

At operation 514 of the method 500, the controller 114A determines the discriminator loss 226 between the input signal 202 and the output signal 218 (i.e., distinguishes between watermark containing signal versus the non-watermark containing signal) using the discriminator 225. The controller 114A trains the watermark encoder 203 to reduce the discriminator loss 226. In one or more embodiments, the discriminator loss 226 is determined using any suitable calculation, such as, using Eq. 9 shown below, where La represents the discriminator loss 226 and D represents a discriminator function used to reduce a difference (domain gap) between the output signal 218 and the input signal 202.

L_{d}=−log(Sigmoid(D(a_{w})) (Eq. 9)

At operation 516 of the method 500, the controller 114A generates a benign output signal 219a and a malicious output signal 219b using the signal transformer 228. The controller 114A generates the benign output signal 219a by performing a benign modification to the output signal 218 (e.g., performing benign modification activities such as noising, compression, amplitude scaling, requantization, resampling, cropping, filtering, denoising, encoding, decoding, style transfer, or the like). The controller 114A performs a malicious modification (e.g., alters a core information or data within output signal) to the output signal 218 to generate the malicious output signal 219b. As noted above, the encoded watermark 205 is a semi-fragile watermark. The encoded watermark 205 is robust against benign modifications and fragile against malicious modifications to the input signal 202. Stated differently, the malicious modification should cause the encoded watermark 205 to be destroyed in the malicious output signal 219b. In some embodiments, an encoded watermark 205 is deemed to be destroyed (i.e., no longer present within an output signal) when the watermark is altered in a perceptible way to an algorithm running on a controller, such as when the data provided within the encoded watermark 205 is missing and/or a binary pattern or bits within a data stream are altered. On the other hand, the benign modification should have no effect on the encoded watermark 205. The benign output signal 219a should still include the encoded watermark 205. In one or more embodiments, the signal transformer 228 generates the benign output signal 219a using Eq. 10 shown below where

$${a}_{d}^{b}$$

represents a benign output signal 219a G_{b} represents a benign modification function. In one or more embodiments, the benign modification function performs begin modifications on the output signal 218. The signal transformer 228 generates the malicious output signal 219b using Eq. 11 shown below where

$${a}_{d}^{m}$$

represents the malicious output signal 219b Gₘ represents a malicious modification function. In one or more embodiments, the malicious modification function performs malicious modifications on the output signal 218.

$${a}_{d}^{b} = {G}_{b} ( {a}_{w} ) \qquad Eq . 10$$

$${a}_{d}^{m} = {G}_{m} ( {a}_{w} ) \qquad Eq . 11$$

At operation 518, the controller 114A decodes the benign output signal 219a and the malicious output signal 219b to extract the encoded watermark 205 from each signal. The controller 114A, using the decoder 230B, extracts the encoded watermark 205 from each signal by first decomposing the benign output signal 219a and the malicious output signal 219b. The controller 114A decomposes the benign output signal 219a and the malicious output signal 219b individually into real signal data and imaginary signal data. In one or more embodiments, the using the decoder 230B, the controller 114A decomposes the benign output signal 219a and the malicious output signal 219b using any suitable decomposition process, such as a complex STFT. In one or more embodiments, the benign output signal 219a and the malicious output signal 219b are decoded using Eq. 12 and Eq. 13 shown below, where

$${r}_{d}^{b}$$

represents the real signal data of the benign output signal 219a,

$${i}_{d}^{b}$$

is the imaginary signal data of the benign output signal 219a,

$${r}_{d}^{m}$$

represents the real signal data of the malicious output signal 219b,

$${i}_{d}^{m}$$

is the imaginary signal data of the malicious output signal 219b.

$${r}_{d}^{b} , {i}_{d}^{b} = ComplexSTFT ( {a}_{d}^{b} ) \qquad ( Eq . 12 )$$

$${r}_{d}^{m} , {i}_{d}^{m} = ComplexSTFT ( {a}_{d}^{m} ) \qquad ( Eq . 13 )$$

Next, the controller 114A uses the real signal data and the imaginary signal data of the benign output signal 219a and the malicious output signal 219b to extract the encoded watermark 205 from each signal. An extraction function EX is used to extract the encoded watermark 205 from each signal. In one or more embodiments, the extraction function EX uses any suitable extraction method such as an average pooling strategy. In one or more embodiments, Eq. 14 and Eq. 15 are used to extract the encoded watermarks where

$${w}_{r}^{b}$$

represents the extracted encoded watermark 205 of the benign output signal 219a (the recovered watermark from the benign output signal 219a) and

$${w}_{r}^{m}$$

represents the extracted encoded watermark of the malicious output signal 219b (the recovered watermark from the malicious output signal 219b).

$${w}_{r}^{b} = EX ( {r}_{d}^{b} , {i}_{d}^{b} ) \qquad ( Eq . 14 )$$

$${w}_{r}^{m} = EX ( {r}_{d}^{m} , {i}_{m}^{b} ) \qquad ( Eq . 15 )$$

Next, the encoded watermarks are decoded using a decoding function DE to extract the watermark 201 (the watermark message) from both signals. In one or more embodiments, Eq. 16 and Eq. 17 are used to decode the watermarks where

$${m}_{r}^{b}$$

represents the watermark 201 decoded from the encoded watermark 205 included in the benign output signal 219a and

$${m}_{r}^{m}$$

represents the watermark decoded from the encoded watermark 205 included in the malicious output signal 219b (if any) and DE_{w} represents a watermark decoding function.

$${m}_{r}^{b} = {DE}_{w} ( {w}_{r}^{b} ) \qquad ( Eq . 16 )$$

$${m}_{r}^{m} = {DE}_{w} ( {w}_{r}^{m} ) \qquad ( Eq . 17 )$$

Additionally, or alternatively, during operation 518, decoding the output signal includes determining the probability a watermark is within the benign output signal 219a and the malicious output signal 219b. In one or more embodiments, Eq. 18 and Eq. 19 are used to determine the probability that the benign output signal 219a and the malicious output signal 219b include a watermark. p_{b} represents the probability the benign output signal 219a includes a watermark and pₘ represents the probability the malicious output signal 219b includes a watermark and DEₚ represents a probability decoding function.

$${p}_{b} = {DE}_{p} ( {w}_{r}^{b} ) \qquad Eq . 18$$

$${p}_{m} = {DE}_{p} ( {w}_{r}^{m} ) \qquad Eq . 19$$

At operation 520 of the method 500, the controller determines a robustness loss 228a, a fragility loss 228b, and a probability loss 228c based on the extracted watermark messages. As noted above, the encoded watermark 205 is designed to be fragile to malicious modifications while being robust to benign modifications to the input signal 202. Therefore, the fragility loss 228b is determined based on the difference between the watermark decoded from the encoded watermark 205 included in the malicious output signal 219b and the watermark 201 prior to encoding. In one or more embodiments, the fragility loss 228b is determined using Eq. 20 shown below where “L_{f}” represents the fragility loss 228b and “k” represents a length of the extracted watermark messages, and “m” represents the watermark 201 prior to encoding.

$${L}_{f} = \frac{1}{k} {\sum }_{i = 1}^{k} {( m - {m}_{r}^{m} )}^{2} \qquad ( Eq . 20 )$$

Furthermore, the robustness loss 228a is determined based on the difference between the watermark decoded from the encoded watermark 205 included in the benign output signal 219a and the watermark 201 prior to encoding. In one or more embodiments, the robustness loss 228a is determined using Eq. 21 shown below where “Lᵣ” represents the robustness loss 228a.

$${L}_{r} = \frac{1}{k} {\sum }_{i = 1}^{k} {( m - {m}_{r}^{b} )}^{2} \qquad ( Eq . 21 )$$

In one or embodiments, the probability loss 228c is represented by “Lₚ” and is equal to the probability that the decoded watermark is actually a watermark. In one or more embodiments, the probability is related to the probability that a watermark is present. I

At operation 522 of the method 500, the controller 114A updates the watermark encoder 203 based on the determined losses. The controller 114A updates the watermark encoder 203 based on the imperceptibility loss, the discriminator loss, the fragility loss, and the robustness loss. As noted above, because the encoded watermark 205 is supposed to be imperceptible, the imperceptibility loss is configured to be as small as possible. Because the output signal 218 is supposed to be indistinguishable from the input signal 202, the discriminator loss 226 is configured to be as small as possible. Because the encoded watermark 205 is supposed to be fragile to malicious modifications, the fragility loss 228b is configured to be as high as possible. Because the encoded watermark 205 is configured to be robust to benign modifications, the robustness loss 228a is configured to be as low as possible. Stated differently, the controller 114A based on the determined losses the controller 114A updates (trains) the watermark encoder 203 so that the total loss caused by the encoded watermark is as small as possible. Therefore, the watermark encoder 203 is trained with respect to each of the losses concurrently. The total losses are determined by combining each of the determined losses as in Eq. 22 below where L is the total loss, λᵢ is the hyper-parameter corresponding to the imperceptibility loss, λ_{d} is the hyper-parameter corresponding to the discriminator loss 226, λᵣ is the hyper-parameter corresponding to the robustness loss 228a, λ_{f} is the hyper-parameter corresponding to the fragility loss 228b, λₚ is the hyper-parameter corresponding to the probability loss 228c. In one or more embodiments, the controller 114 trains the watermark encoder 203 by updating each of the hyper-parameters.

L=λᵢ*Lᵢ+λ_{d}*L_{d}+λᵣ*Lᵣ−λ_{f}*L_{f}+λₚ*Lₚ (Eq. 22)

Once a controller 114 has been trained, the learning provided by the training processes completed during the performance of method 500 can then be used by one or more locally trained watermark algorithms (e.g., program 107A) running on the local controller, such as the controller 114A. However, in some embodiments, the learning provided by the training processes can be transferred to one or more electronic components that are in communication with the local controller 114A, such as the second controller 114B. Information relating to learning provided by the training process and/or updated algorithms can be provided to the one or more electronic components, which are in communication with or are to be in communication with the trained controller 114 at some later date, by use of a software update or audio or video conferencing preparatory information provided in a data stream sent to the second controller 114B before or at the start of a scheduled video conference, for example.

As noted above, the increasing risk of cybersecurity threats, including, but not limited to, deepfakes, audio manipulation, video manipulation, and other forms of data tampering requires the need for improved data security mechanisms. Conventional methods of detecting data tampering include passive methods that have diminishing effectiveness as generative models improve, limited generalization across different types of synthesized audio, and computational overhead. Advantageously, the embodiments described herein relate to embedding an input signal with semi-fragile watermark that allows for proactive detection of audio and/or video content that indicates whether the input signal has been maliciously tampered with (i.e., detects cyber security threats).

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving, by a first controller included in a first electronic device, an input signal;
deconstructing, by the first controller, the input signal into real signal data and imaginary signal data;
encoding, by the first controller, the real signal data to generate a real watermark carrier and the imaginary signal data to generate an imaginary watermark carrier;
embedding, by the first controller, the real watermark carrier and the imaginary watermark carrier with an encoded watermark to generate a real embedded watermark carrier and an imaginary embedded watermark carrier;
combining, by the first controller, the real embedded watermark carrier and the imaginary embedded watermark carrier into an output signal, the output signal comprising the input signal embedded with the encoded watermark; and
transmitting, by the first controller, the output signal to a second electronic device.

2. The method of claim 1, wherein the encoded watermark is fragile with respect to malicious modifications to the input signal.

3. The method of claim 2, wherein malicious modifications comprise at least one of: pitch shifting, voice conversion, speech editing, and deepfakes.

4. The method of claim 1, wherein the encoded watermark is robust with respect to benign modifications.

5. The method of claim 4, wherein benign modifications comprise at least one of: noising, compression, amplitude scaling, requantization, resampling, cropping, filtering, denoising, encoding, decoding, and style transfer.

6. The method of claim 1, wherein a second controller of the second electronic device is configured to:
receive the output signal;
decode the output signal; and
flag the output signal if the output signal does not include the encoded watermark.

7. The method of claim 1, wherein a second controller of the second electronic device is configured to:
receive the output signal;
decode the output signal; and
transmit the output signal if the output signal includes the encoded watermark.

8. The method of claim 1, wherein the embedding of the real watermark carrier and the imaginary watermark carrier with the encoded watermark comprises generating the encoded watermark by training a watermark encoder.

9. The method of claim 8, wherein training the watermark encoder comprises training the watermark encoder to reduce an imperceptibility loss and a discriminator loss, and a robustness loss while increasing a fragility loss of the encoded watermark.

10. The method of claim 9, wherein the imperceptibility loss is a mean squared error (MSE) between the input signal and the output signal.

11. The method of claim 1, wherein the deconstructing of the input signal into the real signal data and the imaginary signal data comprises performing a complex Short Time Fourier Transform (STFT) on the input signal, and the combining of the real embedded watermark carrier and the imaginary embedded watermark carrier into the output signal comprises performing an inverse complex STFT on the real embedded watermark carrier and the imaginary embedded watermark carrier.

12. An output signal comprising:
a set of audio data or video data; and
an encoded watermark embedded within the set of audio data or video data, wherein the encoded watermark is robust with respect to benign modifications to the set of audio data or video data and fragile with respect to malicious modifications to the set of audio data or video data.

13. The output signal of claim 12, wherein the encoded watermark the output signal formed by:
receiving, by a controller included in a first electronic device, an input signal;
deconstructing, by the controller, the input signal into real signal data and imaginary signal data;
encoding, by the controller, the real signal data to generate a real watermark carrier and the imaginary signal data to generate an imaginary watermark carrier;
embedding, by the controller, the real watermark carrier and the imaginary watermark carrier with the encoded watermark to generate a real embedded watermark carrier and an imaginary embedded watermark carrier;
combining, by the controller, the real embedded watermark carrier and the imaginary embedded watermark carrier into the output signal; and
providing, by the controller, the output signal to a second electronic device.

14. The output signal of claim 12, wherein malicious modifications comprises at least one of: pitch shifting, voice conversion, speech editing, and deepfakes.

15. The output signal of claim 12, wherein benign modifications comprises at least one of: noising, compression, amplitude scaling, requantization, resampling, cropping, filtering, denoising, encoding, decoding, style transfer.

16. A communication system, comprising:
a first controller included in a first electronic device, the first controller configured to:
receive an input signal;
deconstruct the input signal into real signal data and imaginary signal data;
encode the real signal data to generate a real watermark carrier and the imaginary signal data to generate a imaginary watermark carrier;
embed the real watermark carrier and the imaginary watermark carrier with an encoded watermark to generate a real embedded watermark carrier and a imaginary embedded watermark carrier;
combine the real embedded watermark carrier and the imaginary embedded watermark carrier into an output signal, the output signal comprising the input signal embedded with the encoded watermark; and
transmit the output signal to a second electronic device.

17. The communication system of claim 16, wherein the encoded watermark is fragile with respect to malicious modifications to the input signal.

18. The communication system of claim 17, wherein malicious modifications comprises at least one of: pitch shifting, voice conversion, speech editing, and deepfakes.

19. The communication system of claim 16, wherein the encoded watermark is robust with respect to benign modifications.

20. The communication system of claim 19, wherein benign modifications comprises at least one of: noising, compression, amplitude scaling, requantization, resampling, cropping, filtering, denoising, encoding, decoding, style transfer.
